(19) United States
(12) Patent Application Publication
(10) Pub. No.: US 2017/0087392 A1
(43) Pub. Date: Mar. 30, 2017

(54) FALL PREVENTION SYSTEM FOR PERIPATETIC PERSONS

(71) Applicants: Lee Lambert, Los Angeles, CA (US); Chris Markou, Atlanta, GA (US); Athanassios Sambanis, Los Angeles, CA (US)

(72) Inventors: Lee Lambert, Los Angeles, CA (US); Chris Markou, Atlanta, GA (US); Athanassios Sambanis, Los Angeles, CA (US)

(21) Appl. No.: 15/279,275

(22) Filed: Sep. 28, 2016

Related U.S. Application Data
(60) Provisional application No. 62/233,651, filed on Sep. 28, 2015.

(51) Int. Cl. A62B 35/00

(52) U.S. Cl. CPC A62B 35/0006; A62B 35/0043

(57) ABSTRACT

The present invention provides a personal support system for use by physically disabled and/or otherwise unstable persons. The support system generally includes: a body harness donned by the user; a navigational surface mounted to the ceiling or other overhead support feature in a structure; a device mounted for movement along the navigational surface; a retractable line such as a strap extending between the body harness and mounted moving device; a motor to control the winding and unwinding of the cable/strap; and a control module for the motor.

### REFERENCE TO RELATED APPLICATION

This application derives priority from a provisional U.S. patent application, U.S. Ser. No. 62/233651 filed Sep. 28, 2015 and entitled “Mobile Support System for Physically Disabled and/or Unstable Persons”.

### STATEMENT WITH RESPECT TO GOVERNMENT FUNDING

No government funds were used in the development of this invention.

### BACKGROUND

Field of the Invention

The present invention relates generally to mobility-accommodating systems for preventing personal falls, and more particularly to such systems that support a person's weight to maintain the user in an upright position and prevent him or her from falling while walking within a structure.

Background of the Art

According to the recent professional edition Merck Manual, falls are the leading cause of accidental death in the United States. Indeed, for people aged 65 and over falls are the seventh most frequent cause of death overall. In that age group falls account for three quarters of deaths, as opposed to about one eighth of deaths in the general population. Half of nursing home residents fall; among residents of the outside community, about a third fall. For purposes of epidemiological statistics a fall is formally defined as a person coming to rest on the ground or another lower level; sometimes a body part strikes against an object that breaks the fall. That definition typically excludes falls that are caused by acute disorders (such as stroke or seizure) or overwhelming environmental hazards (such being struck by a moving object).

Falls arise from a widely varied group of causes. The simplest cases are extrinsic environmental hazards, such as tripping over a pet or a door threshold, slipping on a slick surface, or moving through an unfamiliar building. Intrinsic factors include disorders such as inner ear disorders; adverse drug effects; and age-related decline in function. Examples of age-related decline include weakening eyesight, loss of depth perception, lower sensitivity to light and or contrast, failing strength, and reduced balance. Drugs are significant especially where a plurality are used or the drug is psychoactive. Situational factors may aggravate any of these, such as hurrying to a bathroom or telephone, failing to notice an obstruction when talking or multitasking, or having insufficient lighting. Indeed incontinence increases the likelihood of a fall due to the greater frequency of hurrying. In any case the elderly who have fallen at least once are most likely to fall again, especially when muscle weakness is at issue.

Half of the falls among the elderly cause injuries. Although most of those are no worse than scrapes and bruises, many others are quite serious. Broken bones occur especially when osteoporosis is present, and may lead to hospitalization and or death. Thus about 5% of falls fracture the elbow, wrist or pelvis. Moreover, half of the elderly who fall require assistance when rising from the ground there. If not found within two hours after a fall, the victims have an enhanced risk of dehydration, pressure ulcers, rhabdomyolysis, hypothermia, and pneumonia. Long term effects include compromised medical conditions, fearfulness about falling, depression over constraints, and nursing home placement.

Hip fractures represent a particular problem. About 2% of falls among the elderly fracture the hip. One in twenty of those patients die while still in the hospital. In the year following a hip fracture, between one-sixth and one-third of the fall victims die. Half of the mobile elderly who fracture a hip never recover their mobility afterward, and many cease former activities such as shopping or cleaning due to fear of another fall. Yet the resulting inactivity can lead to muscle weakness and stiff joints, further exacerbating their physical limitations.

It is perhaps no surprise, then, that 40% of nursing home admissions are due to falls. Many elderly people in fact do not self-report a fall because it evidences the ravages of age, and or because they wish to avoid interventions by others that would restrict their activities or institutionalize them. And attending physicians often miss a pattern of falls because they do not screen for them routinely unless a patient presents injuries consistent with a fall.

Even so, the medical disorders that contribute to falls are many and diverse. A particularly important group is the disorders affecting blood pressure regulation, such as anemia, arrhythmias, COPD, dehydration, infection, diabetes and hypotension. Other causes include: central processing disorders such as dementia, stroke and delirium; gait disorders such as arthritis, muscle weakness and foot deformities; postural and neuromotor disorders such as Parkinson's disease, stroke and peripheral neuropathy, proprioception disorders such as vitamin B₁₂ deficiency; otolaryngologic disorders such as hearing loss and vertigo; vision disorders such as cataracts, glaucoma and age-related macular degeneration.

Drugs that impair mental functions also contribute to the risk of falls. These include the following categories especially: aminoglycosides, analgesics and opioids in particular, antidepressants, antiarrhythmics, anticholinergics, antihypertensives and vasodilators in particular, antipsychotics, benzodiazepines, and diuretics and high dose loop diuretics.

Fall risk assessments reflect the diversity of their sources. Simple evaluation may include one or more of: a home assessment for hazards; physical examination; review of fall history; and the get-up-and-go test. In the latter the patient rises from a wheelchair, walks in a short loop and returns to sit back down in the wheelchair. There is no standard lab diagnosis; various tests are employed. Neurological exams may also be required.

Ironically post-fall remedies often require the same factor that caused the fall in the first place: physical movement. Thus physical therapy or an exercise program is often prescribed. In many cases these recommend use of an assistive device such as a cane, a wheeled or unwheeled walker, or a modified wheelchair. Environmental measures include the use of supports, slip-resistant shoes, seat belts, modified seating, motion detectors for falls, hip-protective garb, remote alarms, wearable emergency response devices, frequent monitoring by others, and training in improved tactics for supporting oneself physically when rising and resting.

Yet, despite the long history of attempts to prevent falls and mitigate their effects, the associated medical cost in the United States has risen from $20 billion in the year 2000 and to a projected $44 billion for year 2020. Thus there is an urgent ongoing need for devices and systems that will further minimize the risk of falls and improve the quality of life for those who are susceptible to them.

### SUMMARY OF THE INVENTION

Objects and advantages of the present invention include provision of a support system that prevents a user from falling during the user's movements within a structure, thereby to facilitate personal independence, reduce the risk of injury and attendant complications, decrease and simplify the need for assistance, and enable safe and efficient set-up for a user by an assistant. Other objects and advantages of the present invention will in part be obvious, and in part appear hereinafter.

Briefly, the present invention provides a personal support system for users who have a physical disability and/or other physical instability. The support system generally includes: a body harness donned by the user, a navigational surface mounted to a ceiling or to a further component of an overhead mobility template in a structure; a riding link mounted for movement along the navigational surface, a retractable strap extending between the body harness and riding link; a motor to control the winding and unwinding of the cable/strap; and a control module for the motor. In particularly preferred embodiments the motor is powered by an energy storage device such as a rechargeable battery.

In a particular embodiment the invention provides a support system for a user who is at an enhanced risk of a fall when moving peripatetically within a structure, wherein the system comprises:
a) a body harness that, when worn by the user:
   i) comprises at least one strap low-end attachment means, wherein the at least one low-end attachment means is located at or near at least one shoulder of the user when the body harness is worn properly.
   ii) is capable of supporting the user's entire gravitational weight without causing discomfort when the user is in a fall-equivalent position;
   iii) when the user is in a fall-equivalent position, maintains the user's upper body at an angle that is more vertical than horizontal on average along the length of the user's backbone;
b) an overhead mobility template comprising:
   i) at least one navigational surface;
   ii) a riding link that is capable of moving facilely along the navigational surface, and wherein the riding link further comprises a strap high-end attachment means;
   iii) a detachment prevention component that keeps the riding link engaged with the navigational surface;
c) at least one retractable strap, respectively attached at its low end to the strap low-end attachment means of the body harness and at the strap's high end to the strap high-end attachment means of the riding link;
d) a motor to control winding and unwinding of the strap, wherein the motor is affixed to the riding link; and
e) a control module wherein the control module directs the activity of the motor autonomously during winding and unwinding of the strap, and wherein the control module is in electrical, electronic or radiofrequency communication with the motor.

In another particular embodiment the invention provides a support system for a user who is at an enhanced risk of a fall when moving peripatetically within a structure, wherein the system comprises:
a) a body harness that, when worn by the user:
   i) comprises at least one strap low-end attachment means, wherein the at least one low-end attachment means is located at or near at least one shoulder of the user when the body harness is worn properly.
   ii) is capable of supporting the user's entire gravitational weight without causing discomfort when the user is in a fall-equivalent position;
   iii) when the user is in a fall-equivalent position, maintains the user's upper body at an angle that is more vertical than horizontal on average along the length of the user's backbone;
b) an overhead mobility template comprising:
   i) at least one navigational surface;
   ii) a riding link that is capable of moving facilely along the navigational surface, and wherein the riding link further comprises a strap high-end attachment means;
   iii) a detachment prevention component that keeps the riding link engaged with the navigational surface;
c) at least one retractable strap, respectively attached at its low end to the strap low-end attachment means of the body harness and at the strap's high end to the strap high-end attachment means of the riding link;
d) a motor to control winding and unwinding of the strap, wherein the motor is affixed to the riding link;
e) a control module wherein the control module directs the activity of the motor autonomously during winding and unwinding of the strap, and wherein the control module is in electrical, electronic or radiofrequency communication with the motor;
f) a monitor that is in mechanical communication with the strap or electrical communication with the control module or motor, wherein the monitor detects changes in at least one parameter of system operation that is diagnostic for a change in user position that indicates a fall has been prevented; and
g) the navigational surface comprises at least one rail along which at least one wheel of the riding link may pass freely while entrained by the rail.

In still another particular embodiment the invention provides a support system for a user who is at an enhanced risk of a fall when moving peripatetically within a structure, wherein the system comprises:
a) a body harness that, when worn by the user:
   i) comprises at least one strap low-end attachment means, wherein the at least one low-end attachment means is located at or near at least one shoulder of the user when the body harness is worn properly.
   ii) is capable of supporting the user's entire gravitational weight without causing discomfort when the user is in a fall-equivalent position;
   iii) when the user is in a fall-equivalent position, maintains the user's upper body at an angle that is more vertical than horizontal on average along the length of the user's backbone;
b) an overhead mobility template comprising:
   i) at least one navigational surface;
   ii) a riding link that is capable of moving facilely along the navigational surface, and wherein the riding link further comprises a strap high-end attachment means;
   iii) a detachment prevention component that keeps the riding link engaged with the navigational surface;
c) at least one retractable strap, respectively attached at its low end to the strap low-end attachment means of the body harness and at the strap's high end to the strap high-end attachment means of the riding link;
d) a motor to control winding and unwinding of the strap, wherein the motor is affixed to the riding link;
e) a control module wherein the control module directs the activity of the motor autonomously during winding and unwinding of the strap, and wherein the control module is in electrical, electronic or radiofrequency communication with the motor;
f) a monitor that is in mechanical communication with the strap or electrical communication with the control module or motor, wherein the monitor detects changes in at least one parameter of system operation that is diagnostic for a change in user position that indicates a fall has been prevented; and
g) a navigational surface wherein:
   i) to the extent the navigational surface is substantially horizontal, it is characterized by a ferromagnetic smooth uniform surface, and the riding link comprises a permanent magnet, wherein magnetic interaction between the navigational surface and permanent magnet of the riding link is sufficient to support the entire gravitational weight of the user, harness, strap, motor, riding link and any further items that are appended to any of those components; and
   ii) to the extent that the navigational surface is other than substantially horizontal: the navigational surface comprises at least one rail for guiding and entraining a wheel; and the riding link comprises one or more wheels of a size and construction suitable to pass freely while entrained by said rail.

### BRIEF DESCRIPTION OF THE DRAWINGS

The present invention may be more fully understood and appreciated by reference to the following Detailed Description in light of the accompanying drawings, wherein:

FIG. 1 is a caricature of an illustrative nonlimiting embodiment in which a user is wearing a body harness that is attached to a strap.

FIG. 2 is a caricature of an illustrative nonlimiting embodiment in which an affixed overhead mobility template comprises a smooth navigational surface that dips down to the height of a door frame.

FIG. 3 is a caricature of an illustrative nonlimiting embodiment showing a cutaway view at the edge of a navigational surface for which a riding link bearing a strap is held in close proximity.

FIG. 4 is a caricature of an illustrative nonlimiting embodiment in which a user is wearing a body harness that is attached to a strap, and the strap is attached to a riding link that moves along rails mounted at or near the ceiling in a furnished room.

FIG. 5 is a caricature of an illustrative nonlimiting embodiment in which transverse rails on a navigational surface have a junction that allows passage through a doorway and on one side.

FIG. 6 is a caricature of an illustrative nonlimiting embodiment in which a user is wearing a body harness that is attached to a strap, and the strap is attached to a riding link that moves along rails mounted at or near the ceiling along the length of a hallway.

FIG. 7 is a caricature of an illustrative nonlimiting embodiment, with a side-on view illustrating features of the structural support by an overhead mobility template and a configuration for a riding link entrained within a rail or between parallel sheets.

FIG. 8 is a caricature of an illustrative nonlimiting embodiment, with an end-on view illustrating features of the structural support by an overhead mobility template and a configuration for a riding link entrained within a rail.

FIG. 9 is a caricature of an illustrative nonlimiting embodiment in which a user is wearing a body harness that is attached to a strap, that is attached to a rail overhead, wherein the invention permits the user to sit on and rise from a toilet seat.

### DETAILED DESCRIPTION

### Definitions

The invention may be further understood by reference to the definitions provided below.

The term “fall” as used herein means a person's unintentional, uncontrolled sudden movement from a more vertically extended posture to a less vertically extended posture. This definition applies regardless of whether the person's initial posture is one of standing, sitting, kneeling, crouching or another stationary position. This definition also applies regardless of whether the person has the use of a stationary support such as a hand rail or a mobile support such as a cane, walker or wheelchair. And this definition applies regardless of whether immediately prior to the fall the person is engaged in a course of motion such as running, walking, jumping, cycling, or otherwise engaged in a deliberate exercise or other motion. This definition likewise applies regardless of whether the fall occurs by tripping, tipping, toppling, slumping, slipping, sliding, tumbling, cramping, seizure, or another process that is not under the person's control. This definition likewise applies regardless of whether at the end of the fall the person is on the ground or has struck a body part against an object.

The term “at an enhanced risk of a fall” and like terms as used herein means a person who, by reason of a medical condition such as a disorder, disability, weak muscle, use of a mentally impairing drug, or other medical condition, has a higher probability of falling than does a healthy person who is in good physical condition, has a good sense of balance, is mentally competent and has no physical disabilities. This definition applies regardless of whether the enhanced risk is of a permanent or temporary nature

The terms “peripatetic” and “moving peripatetically” as used herein refer to a person who moves from place to place within an area. Such movements may be regular or irregular in their timing. The movements may be separated by pauses of arbitrary duration. The movements may or may not be at certain times of day. Illustrative nonlimiting examples include moving about a home, with pauses to: have a meal in a dining room; visit a bathroom afterward; watch television in a family room; entertain guests in a living room; reorganize a closet; nap in a bedroom; vacuum a hallway; and open an outside door to allow a pet to enter or exit the home.

The term “support system” as used with respect to fall prevention according to the invention means a system that, in the combination of components and modules as described herein, provides suspension within a structure to achieve one or more of the following tasks: break a user's fall gently, return a falling user to an upright position, and or altogether prevent particular falls by a user.

The term “user” means a person who is harnessed within a support system according to the invention, in order to prevent, correct or otherwise mitigate a fall by that person.

The term “structure” means a built structure within which the support system is mounted to prevent, correct or otherwise mitigate a fall by a user. In certain nonlimiting illustrative embodiments the structure is: a room; a hallway; a stairway; an entire floor of a dwelling, i.e., a level of such a dwelling; a portion of an office space; a gymnasium; a workout space such as for use of weight, treadmills or aerobics; a space dedicated to physical therapy or rehabilitation; a covered porch; a covered patio; or a physical work space such as a workshop, garage, barn, greenhouse or large trellis; or an open framework of timbers.

The term “body harness” means a harness that is worn by a user of the support system. In particular embodiments the harness is securely fastened. In certain embodiments the harness is sufficiently padded and or flexible to leave the user feeling comfortable even when all of the user's weight is supported by the harness in suspension. In various embodiments part or all of the harness encircles the midsection of a user's body, for instance with the top edge of the encircling portion being at or below a user's armpits. In some embodiments the harness wraps around the user's thigh. In various embodiments the harness has portions that cross over or rise to at least the level of the shoulders. In further embodiments the harness has a means to attach it to one or more straps to enable suspension forces to hold a user in a more vertical. Except to the extent necessary to protect the user during a fall without dropping him or her, the term body harness as used herein does not limit the following: the types of buckles, clasps, ties, clamps or other attachment components; the type of belts, wraps, panels, stitching or other holding designs; or the type of fabrics, metals, polymeric materials, or other materials, employed in any component.

The term “closure means” when used with respect to a portion of a body harness refers to a means for connecting parts of the harness to each other, for instance to attach ends to complete the circle of an encircling portion, or to attach flaps to an encircling portion, or to attach fabric ends for wrapping about a thigh. In particular non-limiting examples embodiments such closure means for a portion of a body harness include ties, tapes, clips, clasps, buckles, hook-and-loop fabric pairs such as are used in Velcro® strips, S-hooks and carabiners.

The term “worn” as used with reference to a user and a body harness means that the user is in fact wearing the body harness properly in its intended manner. That is:

the user falls within the prescribed limits for weight and size for the harness; the body parts served by the respective parts of the harness are properly engaged therein; attachment components for the harness are properly fastened to ensure the user's safety; and the like.

The term “strap”, as used with reference to a support system according to the invention, means an element that at its lower end can be attached to the body harness of a user and at its upper end can be attached to an overhead component, thereby facilitating partial or full suspension of the user in the event of a fall-like incident. The term strap is used in a broad sense herein, and contemplates the use of cables, chains, ropes, belts, panels of fabrics, rods and slats with teeth that permit ratcheting, and the like. The term strap contemplates the use of a single strap or a plurality of straps. In a particularly preferred embodiment the strap is belt-like, however the invention is not so limited. In certain embodiments a strap has some degree of elasticity; in certain other embodiments it does not. In various alternative embodiments one or more portions of a strap have some degree of elasticity whereas one or more other portions of the strap do not. In certain embodiments the strap has a plurality of components, such as a yoke whereby it is connected with another strap, or such as one or more stiff portions optionally linked by a hinge; or such as one or more flexible portions such as a belt and chain; and various combinations thereof. Such multi-component assemblies are contemplated herein as straps.

The term “configured” as used with respect to a strap attached to a body harness refers to the combined placement, orientation and attachment of the strap relative to the body harness, that is, the term refers to the engineering design for combining the strap with the body harness.

The term “no significant pressure” as used to refer to the effect of a strap against a user's body part such as the head, neck or other body part means that any pressure or tension from the strap when in use as described produces no substantial discomfort or persistent medical aftereffects for the respective body part.

The term “low-end attachment means” as used with respect to a strap refers to a means for attaching a strap to a body harness. Nonexclusive illustrative examples of such means include readily reversible components such as ties, clasps, clips, carabiners, buckles, S-hooks, buttons, key-ring-type connectors, and hook fabrics mated with loop fabrics. Nonexclusive illustrative examples of such means include permanent components such as sewn connections, welded metal connections, welded plastic connections, connections in which a strap is comprised of the same piece of fabric as a harness, and the like.

The term “location” when used with respect to a strap low-end attachment means on a harness refers to the point of attachment on the harness. In particularly useful embodiments the location is on, at or near a shoulder of the user when the harness is worn properly. In certain embodiments the location is to the rear of, side of, or front of a shoulder.

The term “worn properly” as used with respect to a user in a body harness means that the user is wearing as prescribed by the manufacturer, or as is otherwise usual and customary for the method of wearing body harnesses that are used in the prevention of falls.

The term “entire gravitational weight” with reference to the weight of a user in a body harness, means the full weight as if the user was lifted off the floor through a connection with the harness.

The term “capable of supporting” with respect to a body harness supporting a user's gravitational weight means that the harness can support the user's weight without coming apart, tearing, breaking, or otherwise undergoing mechanical compromise.

Where the term “capable of supporting” is otherwise used with respect to a user's weight either alone or in combination with the weight of other components such as a harness, strap, motor, or the like, it means that the item that is capable of supporting that weight likewise will not be mechanically compromised when that amount of weight is borne by it.

The term “without causing discomfort” when used with respect to a harness that prevents a fall by a user wearing that harness, means that the effect of the user's physical contact with the harness during the incident causes no substantial or lasting sense of chafing, excessive tightness, or other discomfort for the user.

The term “fall-equivalent position” refers to the position of a user in a body harness after an incident in which the user would have fallen but for the use of the harness. In particular embodiments, nonlimiting examples of the fall-equivalent position may be: suspension by the harness a short distance above the floor; bent over; crouched; leaning; and kneeling positions with feet but not knees in contact with the floor.

The term “fall-equivalent incident” refers to an incident where, but for the use of the present invention, the user would have fallen.

The term “upper body” as used with respect to a user of a body harness means the portion of the body that is above the waist.

The term “more vertical than horizontal on average along the length of the user's backbone” as used with respect to the upper body means that if a line were drawn through the top end and lowest point of the user's spine running through the upper body, the line would form an angle greater than 45 degrees relative to horizontal.

The term “maintain” as used with respect to the angle of a user's body maintained by a body harness means that the harness holds the body such that it does not fall to a more acute angle with horizontal than the one that is described.

The term “overhead mobility template” means an apparatus mounted above a user in a body harness, whereby falls by the user may be prevented by means of one or more straps extending between the harness and the overhead mobility template. In particular embodiments the template comprises: mechanical components such as beams for mounting in a building; an engineered surface that is attached to the underside mechanical component and serves as a lowered ceiling to serve as a navigational surface; a device that is held to but can roll or slide along the underside of the lowered ceiling and when attached to a strap can allow it to act as a peripatetic tether; and a means for holding the moving device in close proximity to the lowered ceiling. The engineered surface is called herein a navigational surface; the mobile device is called herein a riding link; and the proximity-maintaining means is called herein a detachment prevention component. In some embodiments the overhead mobility template is attached directly to a ceiling, in other embodiments it may be attached to walls or posts or beams but not a ceiling, in further embodiments it may be attached to some combination of the foregoing. In certain embodiments the overhead mobility template is attached to a structure that is suspended from or otherwise positioned below an existing ceiling.

The term “navigational surface” refers to a structure that serves as a substitute ceiling, whereby a user in a body harness below may move along one or more paths, or in some embodiments anywhere in an area, and features of the navigational surface define the paths or area. Non-limiting illustrative features include rails, horizontal surfaces, arches, dips, and angled surfaces such as over stairs.

The term “substantially horizontal” as used with respect to a navigational surface means that the referenced surface area differs on average from horizontal by an angle that is selected from no more than one of the following: 1°, 2°, 3°, 4°, 5°, 6°, 7°, 8°, 9°, or 10°.

The term “riding link” means a device that is held to but can roll or slide along the underside of the navigational surface. When attached to a strap the riding link allows it to be used as a tether, but with the upper end free to move through paths or areas defined by the navigational surface.

The term “moving facilely along” with respect to a riding link on a navigational surface means that when subject to lateral forces applied through a strap suspended from the riding link, the riding link is able to move along the surface with essentially no more than usual force generated by a person walking across the room. In particular embodiments the riding link rolls or slides across the navigational surface with relatively little friction.

The term “high-end attachment means” as used with respect to a strap refers to a means for attaching a strap to a motor on a riding link. Nonexclusive illustrative examples of such means include readily reversible components such as reels, spools, ties, clasps, clips, carabiners, buckles, S-hooks, buttons, key-ring-type connectors, and hook fabrics mated with loop fabrics. Nonexclusive illustrative examples of such means include ties, permanent components such as sewn connections, welded metal connections, welded plastic connections, connections in which a strap is comprised of the same piece of material that is part of the riding link, and the like.

The term “detachment prevention component” means a component that holds the riding link in close proximity to the navigational surface. Where the navigational surface is comprised of ferromagnetic materials, the detachment prevention component may be a permanent magnet or an electromagnet. In particularly preferred embodiments for ferromagnetic navigational surfaces it is a permanent magnet. In certain other embodiments the navigational surface comprises a rail and the detachment prevention component is a wheel mounted on a riding link, and the wheel is entrained in the rail.

The term “engaged with” as used with respect to a riding link on a navigational surface means that the riding link will not separate from the navigational surface when less than a critical amount of force is applied in a direction orthogonal to the location on the navigational surface where riding link is residing. In particular embodiments the critical amount of force is specified in terms of the user's gravitational weight: in various non-limiting examples the force is at least one of the following: 150%, 175%, 200%, 250%, 300%, 350%, 400%, 450%, 500%, 600%, 700%, 800%, 900% or 1000% relative to the gravitational weight of the user's body.

The term “retractable” as used with respect to a strap means that slack in the strap may be taken up reversibly, for instance on a reel, in a coil, or loosely within a housing. In particularly preferred embodiments the strap is wound and unwound as needed.

The term “motor” has its usual and ordinary meaning in the mechanical arts, and is not limited to a particular type of motor. In preferred embodiments the motor is powered by one of a battery, fuel cell or electrical transmission line. In particularly preferred embodiments the motor is powered by a battery. The term “electrical motor” means a motor that is powered by electrical current.

The terms “battery” and “fuel cell” have their usual and ordinary meaning in the arts of electrical storage. The term “electrical transmission line” means a cord, cable, or other electrically conducting transmission line through which electrical current is conveyed.

The terms “winding” and “unwinding” have their usual and ordinary meanings for straps, cables, chains and other linear tethers on a reel or spool. The term further encompasses the taking up and release of such lines by a block and tackle, optionally with a quick release switch.

The term “control” as used with respect to winding, unwinding and or other activity by means of a motor means that the motor drives the respective action.

The term “modulate power” as used with respect to electrical power means that the power level is modified in a deliberate way.

The term “cause gear shifting” with respect to an effect on a motor means that the effect results in shifting from one gear to another in the motor.

The term “brake” has its usual and ordinary meaning in mechanical engineering.

The term “secondary motor” means a motor that, when engaged, supplements or alternatively opposes the work done by another motor, as the term work is understood in physics.

The terms “pressure” and “tension” have their usual and ordinary meaning in physics.

The term “falls below a specific threshold” as used with respect to tension or pressure means that the specified threshold is not reached under the conditions recited.

The term “affixed” as used with respect to two items means that they are attached to each other. For example, where a motor or other object is affixed on a riding link means that the object is mechanically attached to the riding link. Where an overhead mobility template is affixed to a ceiling, the template is attached thereto. Non-limiting examples of affixing include: being held within the same housing; one component being attached to the housing of the other; and use of bands, screws, bolts, welds, glues, tab-in-slot designs, or friction fits to hold one to the other.

The term “control module” as used with respect to autonomous management of motor activity means that the module operates according to programmed instructions that are either in the form of software or a computer chip, wherein an algorithm processes inputs from a sensor regarding tension and or direction, and a module employs the algorithm to determine when and how much to cause the motor to engage, change speed, reverse, disengage and or brake. In particular embodiments the algorithm controls the winding and unwinding of a strop. In certain embodiments the algorithm employs inputs as to a least one of the user's height, weight, and physical condition. In various embodiments one or more control modules direct motors for a plurality of straps, and the algorithm responses are different for at least one strap, such as for example, where one but not both legs of a user is recovering from an injury.

The term(s) “setting(s)” as used with respect to the control module refer to the programmed settings for variables in its output to control a motor's operation. The term “specification” as used with respect to such settings means the values and or ranges of values for the outputs to which the control module is directed.

The term “algorithm” has its usual and ordinary meaning in mathematics and computer science.

The term “permanent part of the hardware” as used with respect to an algorithm mean that it is hardwired, for instance, is provided in a computer chip.

The term “programmed into the hardware” as used with respect to an algorithm mean that it is provided as a set of instructions, for instance, is provided in computer software.

The term “inputs for settings that are otherwise fixed by algorithms that are a permanent part of the hardware” means that the permanent algorithms in the hardware provide a plurality of options from which a setting may be selected for at least one category of settings.

The term “directs the activity” as used with respect to the effect of a control module on a motor means that the module essentially drives the motor. In non-limiting examples the module directs activity by altering the voltage or current applied to a motor. In some non-limiting examples the module directs activity by switching the motor on or off. In certain non-limiting examples the module directs activity by causing the motor to change gears.

The terms “autonomous” and “autonomously” as used with respect to directing the activity of a motor have their usual and ordinary meanings in the field of robotics.

The term “in electrical communication with” as used with respect to a control module and a motor means that inputs from the control module to the motor are in the form of direct or alternating current, such as where the control module switches the motor on or off. The term “in electrical communication with” as used with respect to a monitor and either a motor or control module means that inputs from the monitor to the other component are in the form of direct or alternating current.

The term “in electronic communication with” as used with respect to a control module and a motor means that inputs from the control module are modulated electronically, for instance by means of transistors or other electronic components.

The term “in radiofrequency communication with” as used with respect to a control module and a motor means that inputs from the control module are transmitted wirelessly to the motor or to a module on the motor, for instance by wireless telephonic transmissions.

The term “in mechanical communication with” as used with respect to a monitor and a strap means that the monitor is mechanically connected to and capable of measuring the tension on a strap.

The term “parameter of system operation” means a predefined metric concerning activity, location, fitness, or body position of the user. Non-limiting illustrative examples of parameters of system operation include: the user's lateral rate of speed; height of a worn monitor above a floor; the user's heart rate; the angle of the user's upper body; location of the user within a house; and amount of time resting at one location.

The term “change” as used with respect to parameters of system operation means differences over specific periods of time. In various embodiments the change may be measured in terms of hours, minutes, seconds, and fractions of a second. In certain embodiments the change may be measured in terms of percentage differences, absolute differences, differences from projected values, or differences from ideal values. In further embodiments the change may be measured in terms of distance, frequency, speed, or force.

The term “diagnostic” with respect to parameter changes that indicate or detect fall prevention means that the measured parameter change is regarded as correlated with prevention of the fall.

The terms “change in user position” and “position change” refer to a difference in a user's body position. Non-limiting examples include sitting or laying down, rising from a seat or bed, and bending over. Changes in user position that are diagnostic for prevention of a fall may include but are not limited to tripping, tilting, leaning and slumping, where it is understood that had a suspended body harness not constrained downward movement, the user would have come to rest on a floor or otherwise have fallen against a wall or other object.

The term “tracks the location” as used with respect to a monitor tracking a user means that the monitor indicates the user's location, for instance within a house.

The term “vertical speed of position change” as used with respect to a user contemplates differences for normal position change as opposed to a fall. For example, a sudden change may be regarded as diagnostic for a fall, whereas slow changes may be regarded as diagnostic for sitting down or rising from a chair.

The term “peripatetic movement history” means a chronological record of a user's movement. In non-limiting illustrations, the history is selected from one of the following: continuous; taken at defined intervals of time; taken during prevented falls; or some combination of these.

The term “monitor-perceived” as used with respect to fall-like incidents means that a threshold was passed at which a change in a parameter indicates that a fall would have taken place had it not been prevented.

The term “alarm” has its usual and ordinary meaning in devices. In some embodiment the alarm alerts others who are with or near a user. In certain other embodiments the alarm alerts others who are remote from the user.

The term “signal” as used with respect to an alarm refers to the means by which the alarm is communicated. The terms “audible” and “telephonic” have their usual and ordinary meaning for the transmission of alarm signals. The term “short-range radiofrequency signal” refers to signals that are communicated such as by RFID, Bluetooth, citizen's band radio, walkie-talkie, and other signaling means. The term “vibrational signals” means signals such as by vibrating a device on the person of a third party. The term “light-bearing signals” means signals such as a blinking light, a strobe, an indicator light on a control panel, an infrared light for communication between computers, and the like.

The term “rail” as used with respect to a navigational surface means a feature through or along which a wheel can move freely while entrained. In a non-limiting illustrative embodiment the rail is analogous to a tube having a length-wise slot, such that an axle extends through the slot between the wheel inside the tube and a riding link outside the tube, and there is no obstacle to the axle's passing along the slot when the wheel is rolling freely in the tube. In certain embodiments the rail may be configured such that the wheel may readily become unentrained outside either end of the rail, but may be funneled to be entrained by the rail when entering from either end, such as where a rail is provided above a staircase but a user has more latitude to move on the upper and lower stories themselves. In particular embodiments a rail provides mechanical constraints to keep the riding link in close proximity to the navigational surface for some sections of a navigational surface, and for other sections of the same navigational surface magnetic forces keep the riding link in close proximity to that surface. In some embodiments the riding link is maintained in close proximity to a navigational surface by means of a rail alone. The location and direction of a rail may serve as a guide for a riding link.

The term “entrain” as used with respect to one or more wheels on a rail means that the wheels do not become separated from the rail along portions of the rail where the entrainment occurs. The entrainment may occur by, for instance, a C-shaped configuration that reaches around from the outside edge to the inside edge of the wheel. Alternatively the entrainment may occur by riding the outside of the rail, for instance where the rail is flanged, and a riding link curls around the rail in a C-type configuration with a wheel at each end, such that the flanges prevent the riding link from falling off. Various other designs for entrainment will occur to the person of ordinary skill in the art.

The term “wheel” has its usual and ordinary meaning in the mechanical arts and includes disk-shaped wheels, cylindrical wheels, sphere-like wheels within shell-like housings, wheels bearing tires, wheels that are free of tires, polygon-shaped wheels, wheels with brakes, flanged wheels, wheelsets, and other types of wheels. Where wheels pass through a rail, it is understood that the size and shape of the wheel must be such that distance between the axle and the rolling contact surface of the wheel is matched to the distance between the inner contact surface of the rail and the slot, so that the wheel may pass freely through the rail when the wheel is entrained there. This is what is meant by the size and construction of the wheel being suitable to pass freely while entrained by the rail.

The term “fall hazard” means an object or arrangement of objects wherein a user passing over or near them is anticipated to have a greater probability for a fall. The terms “step”, “stairs”, and “ramp” have their usual and ordinary meaning in the architectural arts. The term “location adjacent to an edge of a height” means a location adjacent to a point from which a user could fall off the edge, for instance the edge of a porch, deck, loft or ramp that has no guardrail, or a step on a staircase, or the edge of a swimming pool.

The term “free from electrification” as used with respect to an overhead mobility template means that no electrical current is supplied to the template, for instance it is free of all of the following: a powered third rail such as are used for subway electrification; electromagnets; induction currents; and the like.

The term “rechargeable battery” has its usual and ordinary meaning in the arts of energy storage. Where a rechargeable battery is recited herein as employed to power a motor, it means that the motor runs on current drawn from that battery. In certain embodiments a plurality of rechargeable batteries may be used to power a motor, whether in series to increase the voltage, or in parallel to increase the amperage, or any combination thereof

The term “electrical charging dock” as used with respect to a rechargeable battery means a station at which electrical current is made available to charge or recharge such a battery. The term “charge” as used herein encompasses each of initially charging, recharging and reiteratively charging a battery. The term “when not in use” as used with respect to an electrical charging dock means that the dock is not in electrical communication with any of a charged, discharged or partially charged battery.

The term “spare” as used with respect to a rechargeable battery means a battery that may be used as a reserve battery, back-up battery, battery used in rotation with at least one other, or otherwise surplus rechargeable battery.

The term “ferromagnetic” has its usual and ordinary meaning in the arts of materials science, physics and engineering. The term “ferromagnetic sheet” means a sheet comprised of ferromagnetic material. In certain embodiments of the present invention sheets of a ferromagnetic metal such as steel are employed in this respect. The term “material” has its usual and ordinary meaning in materials science.

The term “permanent magnet” means an object constructed from a material that is magnetized and that creates its own persistent magnetic field. Particularly preferred materials for permanent magnets employed in the present invention include materials with high coercivity, and in particular alnico and ferrite magnets.

The term “force” has its usual and ordinary meaning in physics.

The terms “sufficient to support” and “sufficiently strong to support the weight” as used with respect to the force between a magnet and ferromagnetic sheet means that the referenced weight is less than the force necessary to separate the magnet and ferromagnetic sheet. In particular embodiments the recited weight refers to one or a combination of the following: the riding link, the user, the harness, and the one or more straps. In certain embodiments the critical threshold of force for such a separation is specified in terms of the weight of the user or of the otherwise recited weight(s): in various non-limiting examples the force is at least one of the following: 150%, 175%, 200%, 250%, 300%, 350%, 400%, 450%, 500%, 600%, 700%, 800%, 900% or 1000% relative to the weight.

The term “item(s) appended to” as used with respect to a component means that the item is affixed to that component.

### Overview

As noted above, the present invention provides a personal support system for users who have a physical disability and/or other physical instability. The support system generally includes: a body harness donned by the user, a navigational surface mounted to a ceiling or to a further component of an overhead mobility template in a structure; a riding link mounted for movement along the navigational surface, a retractable strap extending between the body harness and riding link; a motor to control the winding and unwinding of the cable/strap; and a control module for the motor. In particularly preferred embodiments the motor is powered by an energy storage device such as a rechargeable battery.

Particular embodiments overcome common challenges for the access of fall-prone persons in areas such as bathrooms, bedrooms, kitchens, and stairs. Benefits of the invention include enabling independent or more-independent living for users who have permanent or temporary instability or conditions that may put them at risk for falling (elderly, injured, mentally challenged, ill) to walk with minimal supervision without falling. This reduces injury and further complications, decreases the need for assistance, and provides a safer, more efficient safety management system for family members and medical assistants.

Medical benefits for users include those that accompany the exercise they might otherwise avoid, including improved circulation, mood elevation, quality of life and life expectancy. Financial benefits parallel those, including lower costs for in-home care, lower costs for insurance premiums and pay-outs, and lower costs for government in support and subsidies.

### Figures

Various aspects of the invention may be further understood by reference to the drawings. Note that references to straps herein contemplate retractable straps as well as other straps, and further contemplate the use of a motor mounted on or in the riding link to execute the winding and unwinding of the straps, and in addition contemplates the optionally reversible attachment of a power source such as a rechargeable battery, fuel cell or electrical transmission line for purposes of powering the motor.

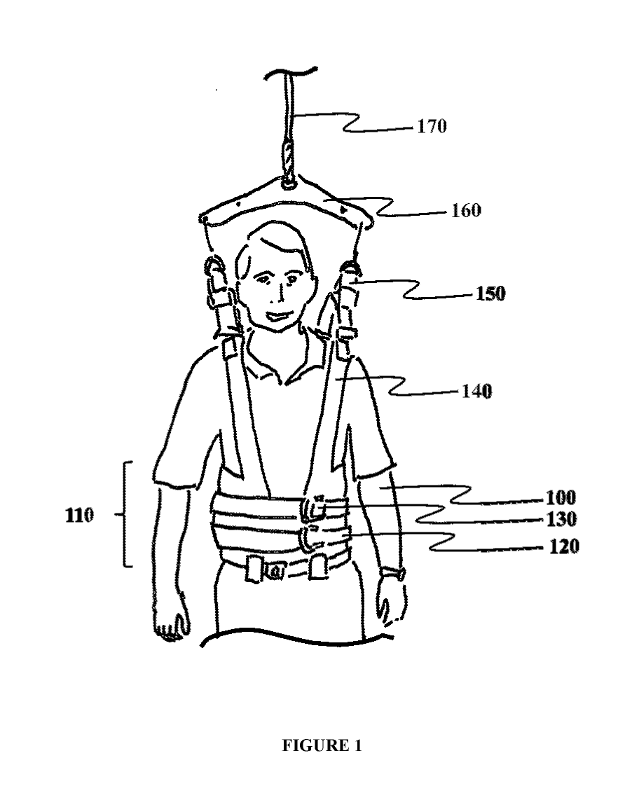

Referring now to FIG. 1, there is seen a user 100 wearing a body harness for which the encircling portion 110 is held about the user's waist by a plurality of belts such as are seen at 120 and clasped by a buckle such as is seen at 130. The encircling portion is one piece with fabric in a suspender-like configuration shown at 140, where that suspender-like component is one of several elements that in combination for a strap, the other elements being: components above the shoulders 150 comprising adjustment features such as buckles and b-rings; a yoke 160 linking the above-shoulder components 150, and a line 170 attached to the yoke 160.

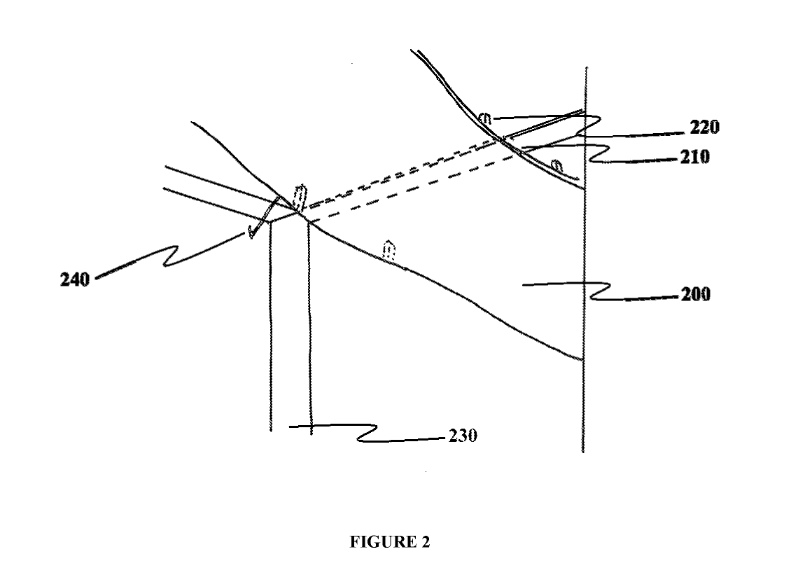

FIG. 2 depicts a navigational surface 200 suspended above but near a doorframe 230 by a crossbeam feature 210, and further attached to the ceiling and walls by other features of the overhead mobility template, such as by pedestal features such as 220 attaching it to a ceiling, and such as a hook 240 holding it against the edge of the door. For purposes of visual clarity the hook is shown hanging away from the door frame, however in particular embodiments it latches against the door frame itself. The smooth character of the navigational surface is particularly useful when it is constituted by a ferromagnetic material, for instance for use with a riding link that houses a permanent magnet. Dipping of the navigational surface near a door frame is particularly useful where the user would simply stand in the doorway as for a small closer, or would pass through the door to exit or enter a building as for an outside door, but the invention is not so limited.

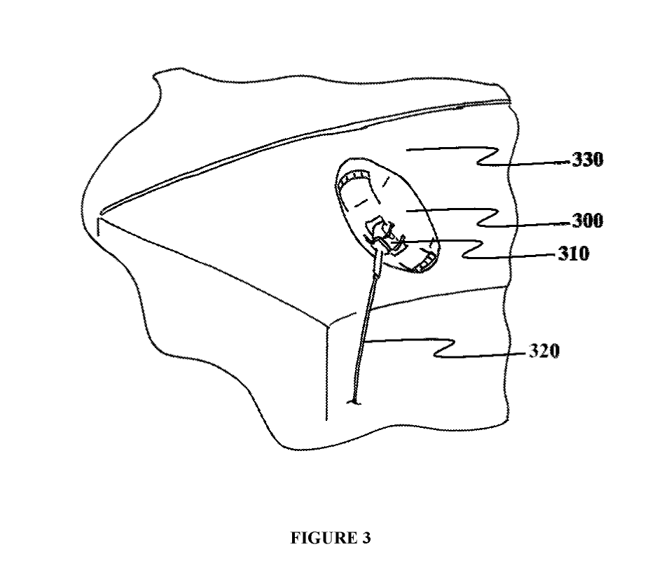

FIG. 3 depicts additional features of the invention. Here a cutaway view depicts the edge of a navigational surface 330. For the sake of clarity and simplicity the rest of the overhead mobility template is omitted from the drawing. Here a riding link 300 has a high-end attachment means 310 for holding a strap 320. In particularly preferred embodiments the navigational surface 330 is ferromagnetic and the riding link 300 houses a permanent magnet. In certain other embodiments the riddling link 300 rolls along the navigational surface on wheels in order to minimize the friction that would otherwise result from the sliding on the navigational surface under the amount of magnetic force that would exist between the permanent magnet and ferromagnetic surface.

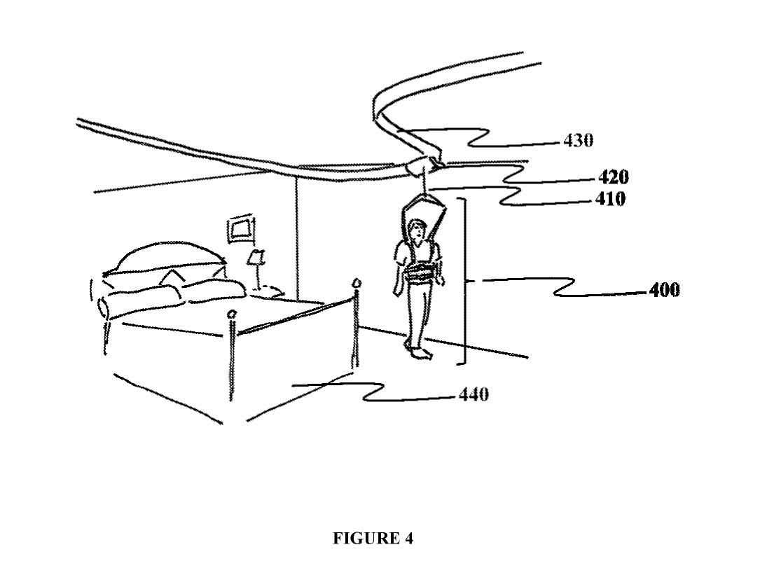

FIG. 4 depicts a navigational surface in the form of a rail 430 placed at or slightly below ceiling level, the rail being engaged with a riding link 420 that is attached to a strap 410 for steadying a user 400; note that components of the strap such as suspender-like portion, above-shoulder extensions and a yoke are part of the strap though they fall within the range of height designated in the figure for the user 400. The winding path of rail 430 allows for facile climbing onto and off of furnishing such as bed 440.

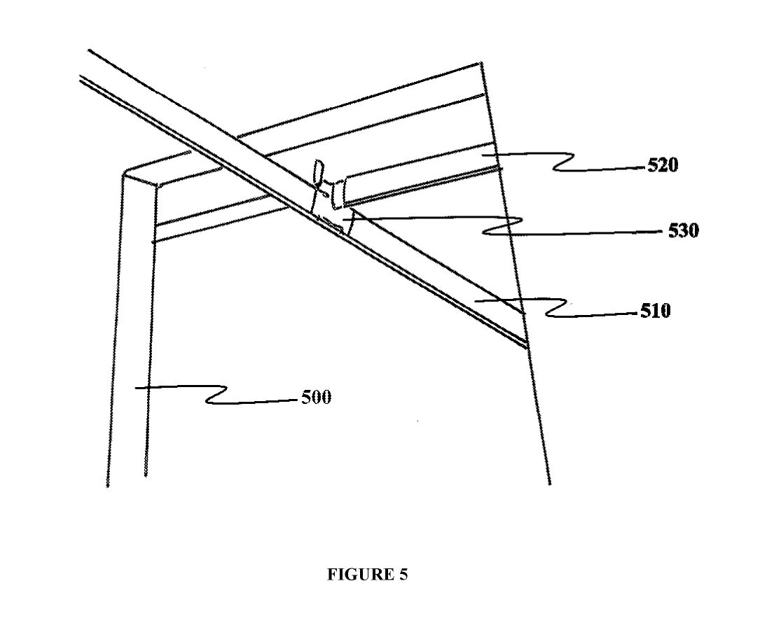

FIG. 5 depicts a rail variation in which a first rail 510 passing through a doorway 500 has a junction 530 with a second rail 520, for instance for use in passing out of a door and turning into a hallway or vice versa.

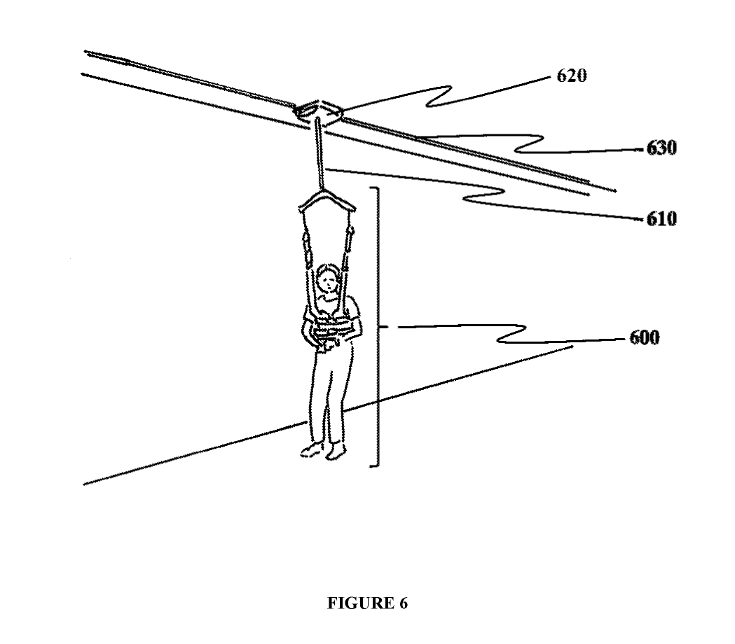

FIG. 6 depicts a user in a body harness, collectively 600, where a strap 610 is comprised of a linear component, a yoke attaching two strap portion, an over-shoulder extension and suspender-like portions. Here the encircling portion of the body harness has a top edge that is near but under the user's armpits. The strap 610 is attached to a riding link 620, which in turn moves along a rail 630 in a hallway. In particular embodiments such a hallway comprises multiple such rails in parallel or otherwise, in order to provide more movement options or to enable more than one user at a time to enjoy the fall prevention hardware.

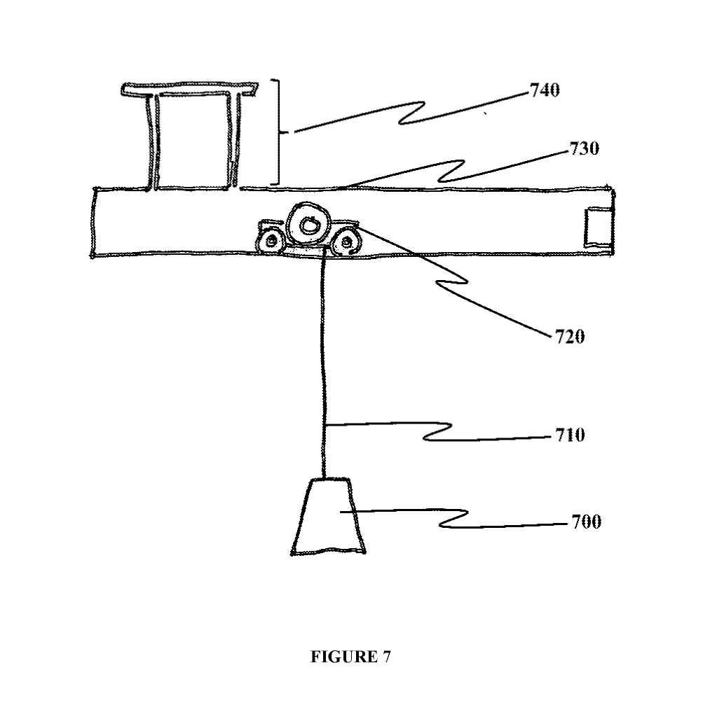

FIG. 7 is a side-on view illustrating additional aspects, such as where a user's gravitational weight, shown generically as 700, is attached to a strap 710, which in turn is attached to a wheeled riding link 720. In this instance the rail 730 comprises a slot to allow for rapid passage of strap 710 through it. The rail 730 is a navigational surface affixed to the overhead mobility template 740, the top of which template is shown in a flattened form suitable for affixing to a ceiling. Note that FIG. 7 also represents the circumstance where 730 provides a hollow place for a riding link to roll between two parallel sheets. The end of rail 730 optionally has a charge docking station for purposes of recharging the battery for the motor for the riding link when the riding link is not in use, and or for purposes of recharging a spare battery that can be swapped into the riding link when convenient.

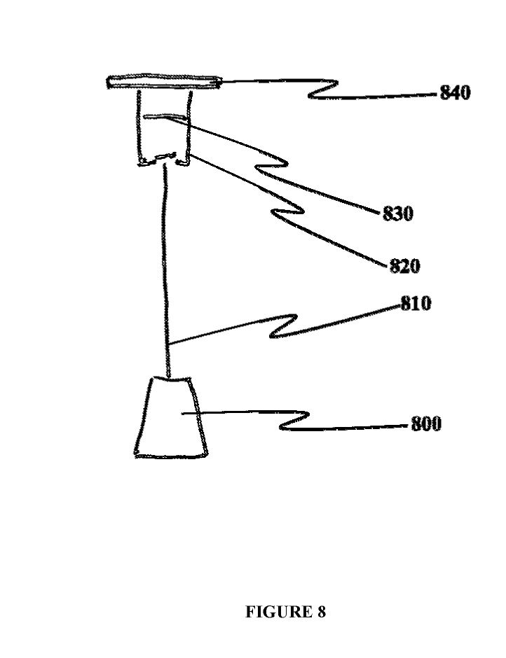

FIG. 8 is an end-on view complementing the illustration shown in FIG. 7, such as where a user's gravitational weight, shown generically as 800, is attached to a strap 810, which in passes through a slot or other orifice in rail 820 (slot not shown) to a motor in a riding link 830 (for which only the top profile is shown. Note that with two grooves at the bottom, the rail is suitable of use with a riding link that has paired wheels on opposite sides. In this instance the rail 730 comprises a slot to allow for rapid passage of strap 710 through it. The rail 830 is a navigational surface affixed to the overhead mobility template 840, the top of which template is shown in a flattened form suitable for affixing to a ceiling.

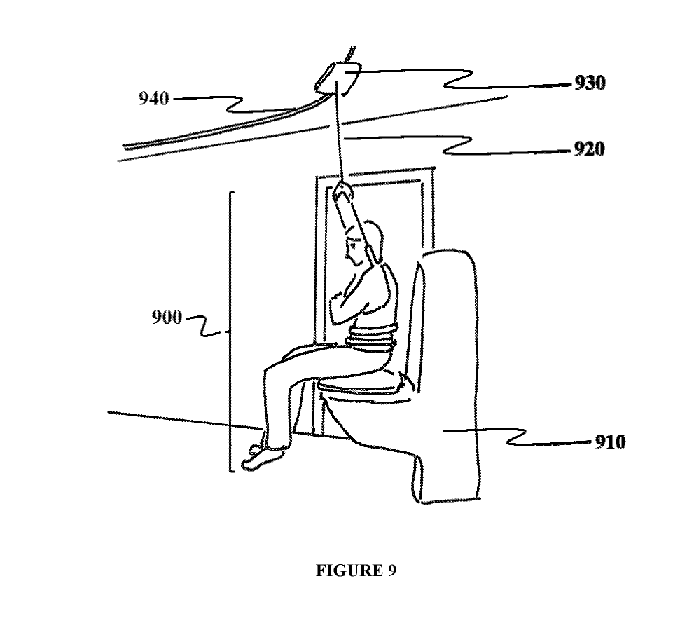

FIG. 9 is a view illustrating use by a user wearing a body harness 900, the harness being attached to a strap by means of at least above-shoulder extensions that are linked by a yoke to a line to form a strap 920, that is suspended by a riding link 930 that rides a rail 940 mounted overhead. The system allows for the comfortable lowering of the user onto a seat—here a toilet seat—and for raising of the user therefrom without discomfort. In particular embodiments the user could manually or by wireless signal activate lowering to and raising from the seat.

Note that in some cases door headers would need to be removed and reframed to make space for a rail or sheet-format navigational surface, while in other cases the navigational surface may be mounted at door height using vertical pedestals extending to the ceiling in spaced intervals sufficient to carry the load imposed by the person.

In various embodiments the user remotely controls the motor, for instance by a handheld wireless device, or by a device attached to the body harness. The motor may be used to adjust strap tension to lower or raising the user, for instance when getting in and out of a car, sitting in a chair or using the toilet, and a manual control device for the motor may comprise a stop switch (not shown) that prevents it from winding the strap/cable to a point that lifts the user off of his or her feet. In some embodiments the stop switch is activated autonomously in the event that the user forgets or omits to stop the motor using the remote control.

A simpler version of the present invention includes only a short length of track mounted above a bed, chair, toilet or other furnishing where sitting, lying down and rising are regular activities. Where a user requires support only for such types of activities, the simpler version may be employed.

### EXAMPLES

### Example 1

### Body Harness

A body harness is employed that encircles the user about the waist, or otherwise about the trunk of the user but has a top edge just below the armpits. The composition of the harness is a tough material such as rip stop nylon fabric, and the harness is padded to reduce the stress of pressure and tension upon the user's body. The harness has a plurality of belts on the outside, in particular embodiments it has two or three adjustable belts wrapped laterally around the outside of the harness, with quick-release clasps or buckles.

### Example 2

### Strap

An adjustable strap is attached at its lower end to the harness. In certain embodiments the attachment is by means of permanent stitching, in others it is by means of detachable such as a clasp, clip, buckle, hook or carabiner. In some embodiments the strap is attached on the back side behind and below the user's head. In preferred embodiments strap components straddle the shoulders with attachments at the front and back of each, extending upward where on each side they attach to the respective ends of a stiff yoke that is above the user's head and shoulders. In certain embodiments the yoke is maintained at a distance from the head and shoulders by stiff components such as slats, to prevent the yoke from coming into contact with the head, thereby causing injury. In various embodiments the yoke and optionally other stiff components of the strap assembly are padded in order to prevent injury to the head in the event of contact. In particular embodiments one or more lines such as cables, chains or belts extend from the yoke to attachment(s) on one or more motors on the riding link.

### Example 3

### Magnetic Riding Link

A housing on wheels holds and surrounds one or more permanent magnets, one or two motors, and at least one rechargeable battery. The one or more magnets collectively have sufficient strength to remain in close proximity with a ferromagnetic metal surface despite the application of an amount of force chosen from the amounts of 300, 400 and 500 pounds in the opposite direction. The one or two motors are each capable of providing sufficient torque to collectively provide amounts of force at levels that are 60, 70, 80 or 90 percent of the collective force rating for the magnet(s). Alternatively motors having less collective torque capacity are employed in combination with a block-and-tackle arrangement is provided to amplify the tension that they are capable of providing. The wheels are capable of rolling freely under the pressure applied by the magnetic force. The battery or batteries have sufficient charge capacity to provide continuous service for at least a period selected from the amount of 15 minutes, 30 minutes, 60 minutes, two hours, four hours, six hours and eight hours.

### Example 4

### Ferromagnetic Navigational Surface

Steel sheet metal is bolted to beams supporting the ceiling of rooms and hallways where the navigational surface is to run on a single story. Door headers are removed and doors are employed that reach the ceiling, and the sheet metal crosses the top of door ways. The sheet metal optionally has a lip at edges that are not against walls, in order to prevent the riding link from being pulled out of bounds from the metal and falling to the floor. In certain embodiments the sheet metal is installed as metal tiles; in some embodiments it is installed as metal panels; in various embodiments the sheet metal is installed as a single piece for the entire navigational surface.

### Example 5

### Mechanical Constraint Riding Link

A housing on wheels holds and surrounds one or two motors, and at least one rechargeable battery. When entrained by a rail, the riding link remains bound to the rail despite the application of an amount of force chosen from the amounts of 300, 400 and 500 pounds in the opposite direction. The one or two motors are each capable of providing sufficient torque to collectively provide amounts of force at levels that are 60, 70, 80 or 90 percent of the collective force rating for engagement between the riding link and rail(s). Alternatively motors having less collective torque capacity are employed in combination with a block-and-tackle arrangement is provided to amplify the tension that they are capable of providing. The wheels are capable of rolling freely within the constraints imposed by the rail. The battery or batteries have sufficient charge capacity to provide continuous service for at least a period selected from the amount of 15 minutes, 30 minutes, 60 minutes, two hours, four hours, six hours and eight hours.

### Example 6

### Rail-Bearing Navigational Surface

A steel rail is bolted to beams supporting the ceiling, and or supported by walls and or door frames. The rail is flanged to prevent separation by wheels that are entrained by the rail. In particular embodiments there is a network of rails that allows the user to choose a plurality of paths when moving about the structure. In certain embodiments a rail dips from the ceiling to the top of a door frame of standard shape and dimensions, thereby allowing use of rails in buildings without removing door headers.

### Example 7

### Manual Control Module

A wireless transmission device is provided that is hand-held or for instance tethered to the body harness so it cannot be dropped or lost. The device has buttons for winding, unwinding, and stopping spooling of the strap. In certain embodiments the device has buttons that accelerate the rate of winding and or unwinding. In particular embodiments the device has buttons that slow but do not stop the rate of winding and or unwinding. In some embodiments the device has a display screen that shows the use history and a record of fall-equivalent events. In further embodiments the device has an alerting mode that allows the user to signal to others that help is needed. In additional embodiments the device has an autonomous alerting mode that signals others when the user has reached a threshold for a fitness parameter, such as heartrate, pulse, prolonged lack of movement, or the like.

### Example 8

### Autonomous Control Module

A wireless transmission device is provided that is mounted on or within the housing of the riding link. The device is programmed with software that collects information transmitted wirelessly from devices comprising one or more meters such as altimeters, speedometers, accelerometers and angle-gauging meters that are mounted on the user's body harness. When the software detects a fall, for instance a change of more than 20 degrees from vertical within a space of two seconds or less, the software directs the motor to rewind the strap until a force of 50 pounds of tension is reached.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. Such modifications, variations and embodiments are contemplated by the invention, and it is intended that the specification and examples be considered as exemplary only, with a true scope and spirit of the invention being indicated by the following claims.

What is claimed is:

1) A support system for a user who is at an enhanced risk of a fall when moving peripatetically within a structure, wherein the system comprises:
a) a body harness that, when worn by the user:
i) comprises at least one strap low-end attachment means, wherein the at least one low-end attachment means is located at or near at least one shoulder of the user when the body harness is worn properly.
ii) is capable of supporting the user's entire gravitational weight without causing discomfort when the user is in a fall-equivalent position;
iii) when the user is in a fall-equivalent position, maintains the user's upper body at an angle that is more vertical than horizontal on average along the length of the user's backbone;
b) an overhead mobility template comprising:
i) at least one navigational surface;
ii) a riding link that is capable of moving facilely along the navigational surface, and wherein the riding link further comprises a strap high-end attachment means;
iii) a detachment prevention component that keeps the riding link engaged with the navigational surface;
c) at least one retractable strap, respectively attached at its low end to the strap low-end attachment means of the body harness and at the strap's high end to the strap high-end attachment means of the riding link;
d) a motor to control winding and unwinding of the strap, wherein the motor is affixed to the riding link; and
e) a control module wherein the control module directs the activity of the motor autonomously during winding and unwinding of the strap, and wherein the control module is in electrical, electronic or radiofrequency communication with the motor.

2) The support system of claim 1, wherein the system further comprises a monitor that is in mechanical communication with the strap or electrical communication with the control module or motor, wherein the monitor detects changes in at least one parameter of system operation that is diagnostic for a change in user position that indicates a fall has been prevented.

3) The support system of claim 1, wherein the system further comprises a monitor that is affixed to the riding link and tracks the location of the user.

4) The support system of claim 1, wherein the system further comprises a recording device that records at least one of a user's peripatetic movement history and vertical speed of position change.

5) The support system of claim 1, wherein the system further comprises an alarm that, in the event of a monitor-perceived fall-equivalent incident, provides a signal selected from at least one of the group consisting of: audible signals; telephonic signals; short-range radiofrequency signals; light-bearing signals; and vibrational signals.

6) The support system of claim 1, wherein a portion of the body harness encircles the user's body in a band below but in near proximity to the user's armpits, wherein:
a) that encircling portion comprises a closure means;
b) the at least one strap and body harness, when attached by the strap low-end attachment means, are configured such that the strap applies no significant pressure to the user's head or neck during a fall-equivalent incident.

7) The support system of claim 1, wherein:
a) the navigational surface comprises at least one rail for guiding and entraining a wheel;
b) the riding link comprises one or more wheels of a size and construction suitable to pass freely while entrained by said rail; and
c) at least one said wheel of the riding link is entrained by the rail.

8) The support system of claim 1, wherein the overhead mobility template is affixed to a ceiling.

9) The support system of claim 1, wherein the overhead mobility template is affixed to an overhead structure that is below but not affixed to a ceiling.

10) The support system of claim 1, wherein the overhead mobility template is affixed to an overhead structure that is above a fall hazard selected from one of the following: a step;
stairs; a ramp, and a location adjacent to an edge of a height.

11) The support system of claim 1, wherein:
a) the overhead mobility template is free from electrification;
b) one or more rechargeable batteries is employed to power the motor that is affixed to the riding link; and
c) an electrical charging dock is provided at an edge of the overhead mobility template such that the one or more rechargeable batteries may be charged there either as spares or when the riding link is not in use.

12) The support system of claim 1, wherein:
a) the navigational surface is a ferromagnetic sheet;
b) the riding link comprises a permanent magnet; and
c) the force between the magnet and the ferromagnetic sheet is sufficiently strong to support the weight of the riding link, the user, the harness and the one or more straps.

13) The support system of claim 1, wherein the riding link has a feature selected from the group consisting of: comprising one or more wheels; comprising a ferromagnetic material; comprising a permanent magnet; or some combination of the above.

14) The support system of claim 1, wherein the motor is an electrical motor and is powered by a means selected from the group consisting of an electrical transmission line, a battery and a fuel cell.

15) The support system of claim 1, wherein the control module controls activity by the motor by a means selected from the group consisting of: modulating power to the motor; causing gear shifting within the motor; causing application of a brake to the motor; causing engaging by a secondary motor to increase or decrease force applied by the motor;.

16) The support system of claim 1, wherein the control module causes halting or slowing of strap unwinding by the motor when tension on a strap from the user's weight on the one or more straps exceeds a specific threshold.

17) The support system of claim 1, wherein the control module causes acceleration of strap winding by the motor when tension on a strap from the user's weight or movement falls below a specific threshold.

18) The support system of claim 1, wherein specifications for settings of the control module are selected from a group consisting of the following: determined by an algorithm that is a permanent part of the hardware; determined by an algorithm that is programmed into the hardware; determined by inputs for settings that are otherwise fixed by algorithms that are a permanent feature of the hardware; and any combination of the above.

19) A support system for a user who is at an enhanced risk of a fall when moving peripatetically within a structure, wherein the system comprises:
a) a body harness that, when worn by the user:
i) comprises at least one strap low-end attachment means, wherein the at least one low-end attachment means is located at or near at least one shoulder of the user when the body harness is worn properly.
ii) is capable of supporting the user's entire gravitational weight without causing discomfort when the user is in a fall-equivalent position;
iii) when the user is in a fall-equivalent position, maintains the user's upper body at an angle that is more vertical than horizontal on average along the length of the user's backbone;
b) an overhead mobility template comprising:
i) at least one navigational surface;
ii) a riding link that is capable of moving facilely along the navigational surface, and wherein the riding link further comprises a strap high-end attachment means;
iii) a detachment prevention component that keeps the riding link engaged with the navigational surface;
c) at least one retractable strap, respectively attached at its low end to the strap low-end attachment means of the body harness and at the strap's high end to the strap high-end attachment means of the riding link;
d) a motor to control winding and unwinding of the strap, wherein the motor is affixed to the riding link;
e) a control module wherein the control module directs the activity of the motor autonomously during winding and unwinding of the strap, and wherein the control module is in electrical, electronic or radiofrequency communication with the motor;
f) a monitor that is in mechanical communication with the strap or electrical communication with the control module or motor, wherein the monitor detects changes in at least one parameter of system operation that is diagnostic for a change in user position that indicates a fall has been prevented; and
g) the navigational surface comprises at least one rail along which at least one wheel of the riding link may pass freely while entrained by the rail.

20) A support system for a user who is at an enhanced risk of a fall when moving peripatetically within a structure, wherein the system comprises:
a) a body harness that, when worn by the user:
i) comprises at least one strap low-end attachment means, wherein the at least one low-end attachment means is located at or near at least one shoulder of the user when the body harness is worn properly.
ii) is capable of supporting the user's entire gravitational weight without causing discomfort when the user is in a fall-equivalent position;
iii) when the user is in a fall-equivalent position, maintains the user's upper body at an angle that is more vertical than horizontal on average along the length of the user's backbone;
b) an overhead mobility template comprising:
i) at least one navigational surface;
ii) a riding link that is capable of moving facilely along the navigational surface, and wherein the riding link further comprises a strap high-end attachment means;
iii) a detachment prevention component that keeps the riding link engaged with the navigational surface;
c) at least one retractable strap, respectively attached at its low end to the strap low-end attachment means of the body harness and at the strap's high end to the strap high-end attachment means of the riding link;
d) a motor to control winding and unwinding of the strap, wherein the motor is affixed to the riding link;
e) a control module wherein the control module directs the activity of the motor autonomously during winding and unwinding of the strap, and wherein the control module is in electrical, electronic or radiofrequency communication with the motor;
f) a monitor that is in mechanical communication with the strap or electrical communication with the control module or motor, wherein the monitor detects changes in at least one parameter of system operation that is diagnostic for a change in user position that indicates a fall has been prevented; and
g) a navigational surface wherein:
i) to the extent the navigational surface is substantially horizontal, it is characterized by a ferromagnetic smooth uniform surface, and the riding link comprises a permanent magnet, wherein magnetic interaction between the navigational surface and permanent magnet of the riding link is sufficient to support the entire gravitational weight of the user, harness, strap, motor, riding link and any further items that are appended to any of those components; and
ii) to the extent that the navigational surface is other than substantially horizontal: the navigational surface comprises at least one rail for guiding and entraining a wheel; and the riding link comprises one or more wheels of a size and construction suitable to pass freely while entrained by said rail.
